(19) United States
(12) Patent Application Publication
(10) Pub. No.: US 2025/0310556 A1
(43) Pub. Date: Oct. 2, 2025

(54) WITHIN-PARALLELOGRAM PREDICTION FOR POLYGON MESH COMPRESSION

(71) Applicant: Tencent America LLC, Palo Alto, CA (US)

(72) Inventors: Chao HUANG, Palo Alto, CA (US); Shan LIU, San Jose, CA (US)

(73) Assignee: Tencent America LLC, Palo Alto, CA (US)

(21) Appl. No.: 19/086,264

(22) Filed: Mar. 21, 2025

Related U.S. Application Data
(60) Provisional application No. 63/570,215, filed on Mar. 26, 2024.
(60) Provisional application No. 63/686,462, filed on Aug. 23, 2024.

(51) Int. Cl. H04N 19/54; H04N 19/44; H04N 19/70

(52) U.S. Cl. CPC H04N 19/54; H04N 19/44; H04N 19/70

(57) ABSTRACT

A bitstream that includes attribute information of a mesh with a plurality of vertices in the mesh is received. Whether a within-parallelogram prediction mode is applicable to a current vertex of the plurality of vertices of the mesh is determined. When the within-parallelogram prediction mode is determined to be applicable to the current vertex of the mesh, one or more within-parallelogram predictions of the current vertex of the mesh are generated. The current vertex of the mesh is reconstructed based on (i) the one or more within-parallelogram predictions and (ii) one of a prediction residual and an index syntax included in the bitstream.

### INCORPORATION BY REFERENCE

The present application claims the benefit of priority to U.S. Provisional Application No. 63/570,215, “WITHIN-PARALLELOGRAM PREDICTION FOR POLYGON MESH COMPRESSION” filed on Mar. 26, 2024, and U.S. Provisional Application No. 63/686,462, “IDENTIFYING MORE VERTICES FOR WITHIN PARALLELOGRAM PREDICTIONS IN MESH COMPRESSION” filed on Aug. 23, 2024. The entire disclosures of the prior applications are hereby incorporated by reference in their entirety.

### TECHNICAL FIELD

The present disclosure describes aspects generally related to mesh coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

Advances in three-dimensional (3D) capture, modeling, and rendering have promoted 3D content across various platforms and devices. For example, a baby's first step in one continent is captured and grandparents may see (and in some cases interact) and enjoy a full immersive experience with the child in another continent. In order to achieve such realism, models are becoming more sophisticated, and a significant amount of data is linked to the creation and consumption of those models. 3D meshes are widely used to represent such immersive contents.

### SUMMARY

Aspects of the disclosure include bitstreams, methods, and apparatuses for mesh processing. In some examples, an apparatus for mesh processing includes processing circuitry.

According to an aspect of the disclosure, a method of mesh decoding is provided. In the method, a bitstream that includes attribute information of a mesh with a plurality of vertices in the mesh is received. Whether a within-parallelogram prediction mode is applicable to a current vertex of the plurality of vertices of the mesh is determined. When the within-parallelogram prediction mode is determined to be applicable to the current vertex of the mesh, one or more within-parallelogram predictions of the current vertex of the mesh are generated. The current vertex of the mesh is reconstructed based on (i) the one or more within-parallelogram predictions and (ii) one of a prediction residual and an index syntax included in the bitstream.

According to another aspect of the disclosure, a method of mesh encoding is provided. In the method, whether a within-parallelogram prediction mode is applicable to a current vertex of a plurality of vertices of a mesh is determined. When the within-parallelogram prediction mode is determined to be applicable to the current vertex of the plurality of vertices of the mesh, one or more within-parallelogram predictions of the current vertex of the mesh are generated. An attribute prediction of the current vertex of the mesh is encoded in a bitstream based on the one or more within-parallelogram predictions.

According to yet another aspect of the disclosure, a method of processing mesh data is provided. In the method, a bitstream of the mesh data is processed according to a format rule. The bitstream includes attribute information of a mesh with a plurality of vertices in the mesh. The format rule specifies that whether a within-parallelogram prediction mode is applicable to a current vertex of the plurality of vertices of the mesh is determined. The format rule specifies that when the within-parallelogram prediction mode is determined to be applicable to the current vertex of the mesh, one or more within-parallelogram predictions of the current vertex of the mesh are generated. The format rule specifies that the current vertex of the mesh is processed based on (i) the one or more within-parallelogram predictions and (ii) one of a prediction residual and an index syntax included in the bitstream.

Aspects of the disclosure also provide an apparatus for mesh encoding. The apparatus for mesh encoding including processing circuitry configured to implement any of the described methods for mesh encoding.

Aspects of the disclosure also provide an apparatus for mesh decoding. The apparatus for mesh decoding including processing circuitry configured to implement any of the described methods for mesh decoding.

Aspects of the disclosure also provide a non-transitory computer-readable medium storing instructions which, when executed by a computer, cause the computer to perform any of the described methods for mesh decoding, encoding, and mesh data processing.

Technical solutions of the disclosure include methods and apparatuses for improving coding accuracy of coding attributes (e.g., positions or texture coordinates) of a polygon mesh based on a within-parallelogram prediction. In an example, a bitstream that includes attribute information of a mesh with a plurality of vertices in the mesh is received. Whether a within-parallelogram prediction mode is applicable to a current vertex of the plurality of vertices of the mesh is determined. When the within-parallelogram prediction mode is determined to be applicable to the current vertex of the mesh, one or more within-parallelogram predictions of the current vertex of the mesh are generated. The current vertex of the mesh is reconstructed based on (i) the one or more within-parallelogram predictions and (ii) one of a prediction residual and an index syntax included in the bitstream. In an aspect, instead of directly using the within-parallelogram prediction, the within-parallelogram prediction may be put in front of other predictions (e.g., a delta coding or an across-parallelogram prediction). A best-performed prediction is selected from the within-parallelogram prediction and the other predictions. In an aspect, an average of multiple within-parallelogram predictions is put in front of the multiple within-parallelogram predictions, and then a prediction (e.g., a best-performed prediction) is selected from the average of the multiple within-parallelogram predictions and the multiple within-parallelogram predictions. In an example, additional vertices are identified for within parallelogram predictions in polygon mesh compression to improve coding accuracy.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4A is a schematic illustration of an example of an across-parallelogram prediction for mesh processing according to an aspect of the disclosure.

FIG. 4B is a schematic illustration of an example of a within-parallelogram prediction according to an aspect of the disclosure.

FIG. 5 is a schematic illustration of an example of a face-fan around a pivot vertex according to an aspect of the disclosure.

FIG. 6 shows a flow chart outlining a mesh decoding process according to some aspects of the disclosure.

FIG. 7 shows a flow chart outlining a mesh encoding process according to some aspects of the disclosure.

FIG. 8 is a schematic illustration of a computer system in accordance with an aspect of the disclosure.

### DETAILED DESCRIPTION

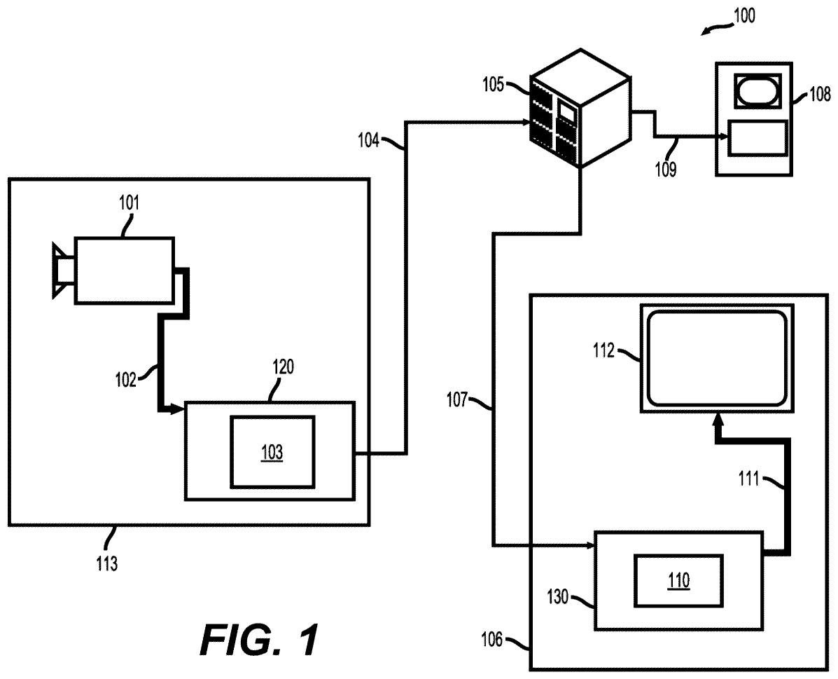

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101). The video source (101) may include one or more images captured by a camera and/or generated by a computer. For example, a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

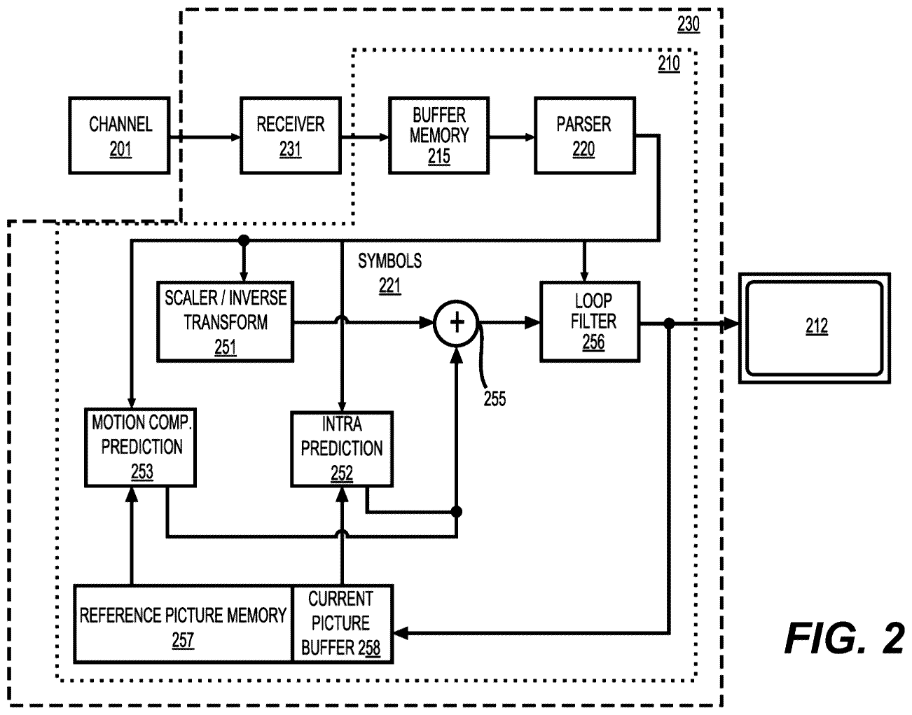

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

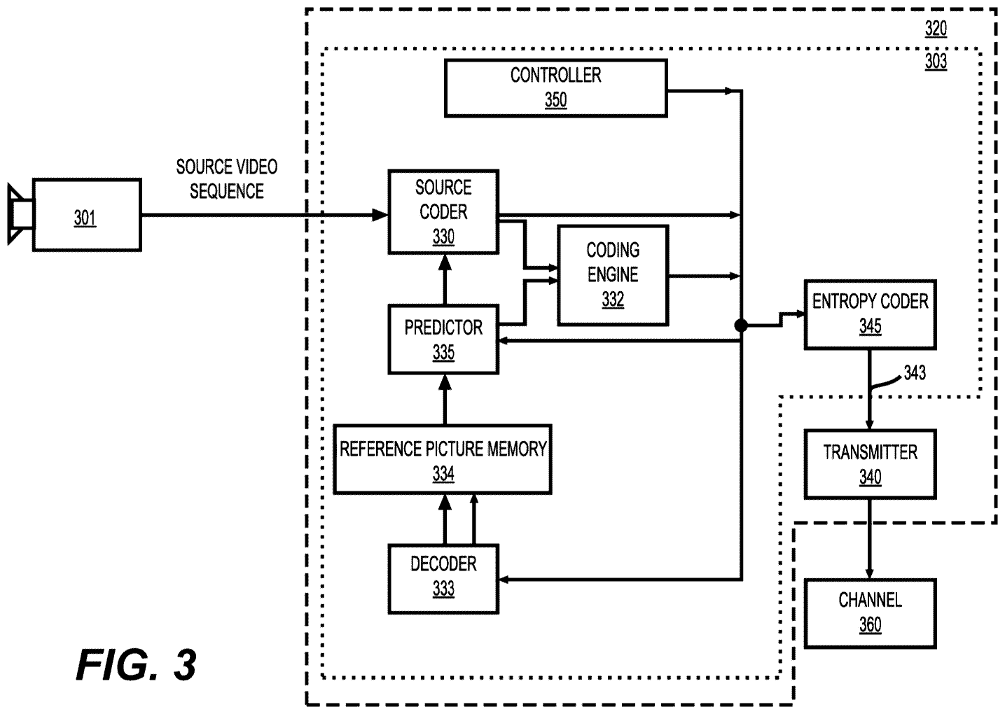

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture (or a mesh) to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks, such as a polygon-shaped or triangular block. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Aspects of the disclosure include methods and systems directed to application of within-parallelogram predictions to efficiently encode positions and other attributes of polygon meshes.

A mesh may include several polygons that describe a surface of a volumetric object. Each polygon may be defined by vertices of the mesh in a 3D space and information of how the vertices are connected, referred to as connectivity information. Vertex attributes, such as colors, normals, displacements, etc., may be associated with the mesh vertices. Attributes may also be associated with a surface of the mesh by exploiting mapping information that parameterizes the mesh with two-dimensional (2D) attribute maps. Such mapping may be described by a set of parametric coordinates, referred to as UV coordinates or texture coordinates, associated with the mesh vertices. 2D attribute maps may be used to store high resolution attribute information such as texture, normals, displacements, etc. Such information may be used for various purposes, such as texture mapping, shading and mesh reconstruction etc.

Mesh compression includes connectivity/topology coding and value coding for each attribute, and value bitstreams may be larger than connectivity bitstreams. To code values of a position and UV attributes, prediction schemes are commonly utilized. For example, a value of each position or UV may be predicted by either using a fixed value (e.g. zeros or centroids), a value of previous position/UV, an average of last n positions/UVs, or a parallelogram prediction. The parallelogram prediction may include an across-parallelogram prediction and a within-parallelogram prediction. Then, prediction residuals may be coded using entropy coding.

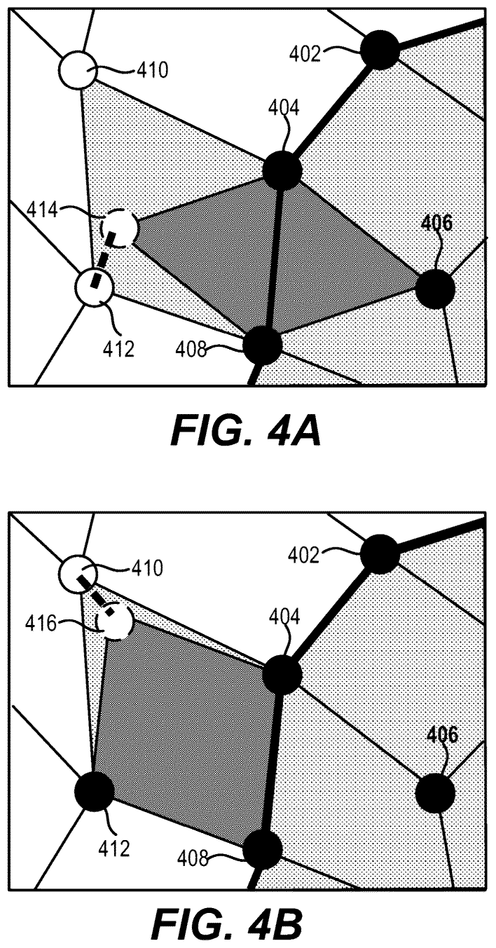

In the across-parallelogram prediction, a position of a vertex may be predicted based on positions of vertices in adjacent polygons. In an aspect, the across-parallelogram prediction may lead to poor predictions if the adjacent polygons are not planar or convex. In the within-parallelogram prediction, a position of a vertex may be predicted based on vertices within a same polygon. Since polygons tend to be fairly planar and convex, the within-parallelogram prediction generally results in more accurate predictions. An example of the across-parallelogram prediction is shown in FIG. 4A and an example of the within-parallelogram prediction is shown in FIG. 4B.

As shown in FIG. 4A, vertices (402), (404), and (406) may form a polygon. Vertices (404), (406), and (408) may form a polygon. Vertices (404), (408), (410), and (412) may form a polygon. According to the across-parallelogram prediction, a position of the vertex (412) may be predicted based on vertices in an adjacent polygon, such as the vertices (404), (406), and (408). According to a parallelogram rule, a prediction (or predicted position) of the vertex (412) is determined as (414).

As shown in FIG. 4B, according to the within-parallelogram prediction, a position of a vertex (410) may be predicted based on vertices in a same polygon, such as the vertices (404), (412), and (408). According to a parallelogram rule, a prediction (or predicted position) of the vertex (410) is determined as (416).

In polygon mesh compression, predictive coding is commonly used to encode attribute values, such as positions or texture coordinates, which can be larger parts of a total bitstream compared to connectivity bitstreams, so efficient methods are needed to code the prediction residuals of those attribute values.

In the disclosure, a plurality of methods is proposed to apply within-parallelogram predictions to encode positions and other attributes of polygon meshes. Those methods may be applied individually or by any form of combinations.

In an aspect, applications of within-parallelogram predictions are provided to encode positions of polygon meshes. A same or similar algorithm for encoding the positions of the polygon meshes may also be applied to encode other attributes, such as texture coordinates, when the parallelogram predictions are applicable to the other attributes.

In an aspect, instead of directly using a within-parallelogram prediction, the within-parallelogram prediction is put in front of other predictions, and a best-performed one (e.g., a prediction with a smallest cost value) is selected from the within-parallelogram prediction and the other predictions. In an aspect, an average of multiple within-parallelogram predictions is put in front of the multiple within-parallelogram predictions, and a best-performed one is selected from the average of the multiple within-parallelogram predictions and the multiple within-parallelogram predictions. In an aspect, the average of the multiple within-parallelogram predictions is put in front of the multiple within-parallelogram predictions and other predictions. A best-performed one is selected from the average of the multiple within-parallelogram predictions, the multiple within-parallelogram predictions, and the other predictions. The other predictions may include an across-parallelogram prediction, a delta coding, or other suitable non-within-parallelogram predictions.

In an aspect, whether a within-parallelogram prediction (or a within-parallelogram prediction mode) is applicable to vertices in a mesh is determined. In an example, at least 3 vertices are required for parallelogram predictions. In an example, in a decoder side, to perform the within-parallelogram prediction, at least 3 vertices (or reconstructed vertices) in a same face are required. In an encoder side, to perform the within-parallelogram prediction, at least 3 encoded vertices in a same face are required. Thus, when a face has a degree of at least 4 (e.g., a face in quad meshes) and 3 vertices in the face have already been encoded, the within-parallelogram prediction (or the within-parallelogram prediction mode) is applicable on encoding rest vertices in the face. In an aspect, a degree of a face in a planar graph is defined as a total number of edges bordering the face. In an example, for a planar graph drawn without edges crossing, a degree of a face is the number of edges in the boundary of the face. It may also be defined as a minimum length of a closed walk that contains all edges of the boundary of the face.

When within-parallelogram predictions are applicable, several ways to utilize prediction results of the within-parallelogram predictions may be applied to encode vertices in a mesh because the within-parallelogram predictions may be more accurate than other predictions, such as across-parallelogram predictions.

In an aspect, other possible predictions (e.g., across-parallelogram predictions or delta coding) are ignored and a within-parallelogram prediction residual obtained from a within-parallelogram prediction is computed. The within-parallelogram prediction residual is then encoded using a coding method, such as an entropy coding. In an aspect, a prediction index is not signaled to indicate which prediction is applied (or selected) as only the within-parallelogram prediction is applied.

In an aspect, other predictions besides the within-parallelogram prediction are also considered. The within-parallelogram prediction is then put in front of all predictions in a candidate list. The candidate list may include the within-parallelogram prediction and the other predictions. The other predictions are put after the within-parallelogram prediction in the candidate list. Accordingly, rare cases where the within-parallelogram prediction is not a most accurate one are covered (or remedied) because the within-parallelogram prediction is a first entry for consideration in the candidate list. When the within-parallelogram prediction is selected, since the within-parallelogram prediction is the first entry in the candidate list, a signaled prediction index may be a smaller than a signaled prediction index that indicates another prediction in the candidate list. As described above, the within-parallelogram prediction may be more accurate than other predictions, separate contexts may be applied to encode a prediction index and a prediction residual respectively when the within-parallelogram prediction is applied.

In an aspect, multiple within-parallelogram predictions are available to predict attributes of a mesh, such as a position or a texture coordinate of the mesh. Prediction results based on the multiple within-parallelogram predictions may be applied the in different ways.

In an example, an average of all available within-parallelogram predictions is applied to predict attributes of the mesh, such as the position or the texture coordinate of the mesh. Accordingly, a prediction index may not be signaled.

In an example, an average prediction (e.g., the average of the within-parallelogram predictions) is put in front of all predictions (or candidate predictions) that includes the average of the multiple within-parallelogram predictions and the multiple within-parallelogram predictions. A prediction index is then signaled to indicate which prediction is selected from the candidate predictions.

In an example, all available within-parallelogram predictions are put in front of all predictions (or candidate predictions) that includes the available within-parallelogram predictions and other predictions. In an example, a most accurate one of the predictions is selected. In an example, one of the predictions that has a smallest bitstream size increase is selected.

In an example, an average prediction is put at a front of all predictions that includes an average of multiple within-parallelogram predictions, the multiple within-parallelogram predictions, and other predictions. In an example, a most accurate one of the predictions is selected. In an example, one of the predictions that has a smallest bitstream size increase is selected.

Aspects of the disclosure include methods and systems directed to identifying additional vertices for within parallelogram predictions in polygon mesh compression.

In polygon mesh compression, within parallelogram predictions may be more accurate than across parallelogram predictions. Identifying more vertices for within parallelogram predictions may improve predictions of positions, UVs, and/or other attribute values of a mesh.

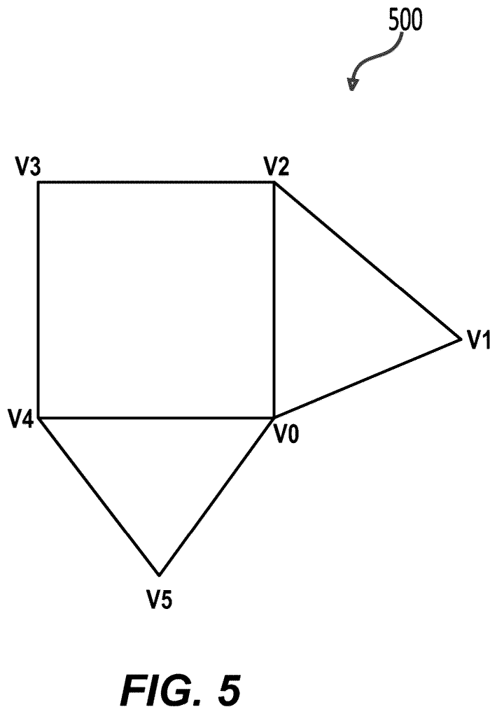

FIG. 5 shows an example of a face-fan (500) around a pivot vertex. As shown in FIG. 5, vertices V1-V5 are vertices on the face-fan (500) around a pivot vertex V0. The face-fan (500) includes a quad face including vertices V0 and V2-V4, a first triangle face including vertices V0-V2, and a second triangle face including vertices V0 and V4-V5. In an example, positions of the vertices V2-V4 incident on the quad face may be predicted, such as based on the within parallelogram prediction. Similarly, the within parallelogram predictions may be applied to predicting UVs and other attribute values of those vertices in the quad face.

In an aspect, within parallelogram prediction is applied to predict a position of a last visited vertex in the quad face. In an example, if a visiting order (or encoding/decoding order) is from vertices V1 to V5, the vertex V4 is the last visited vertex to be encoded/decoded, and vertices V2-V3 are already visited (or encoded/decoded). Accordingly, the vertices V2-V3 and the pivot vertex V0 are used to predict a position of the vertex V4 as p₄=p₀+p₃−p₂ based on the within parallelogram prediction, where pᵢ is a position of i-th vertex. In an example, if the visiting order is from vertices V5 to V1, the vertex V2 is the last visited vertex of the quad face. A position of the vertex V2 is predicted using the within parallelogram prediction as p₂=p₀+p₃−p₄.

In an aspect, besides using the within parallelogram prediction to predict the position of the last visited vertex of a quad face as described above, the within parallelogram prediction is applied to predict a position of a vertex on a quad face when other vertices, such as the other three vertices, on the same quad face have been encoded/decoded. In an example, when (i) the visiting order is from vertices V1 to V5, (ii) the vertex V3 is a vertex to be encoded/decoded, and (iii) the vertex V4 is a split vertex (which indicates that the vertex V4 has been visited before the vertex V0 becomes the pivot vertex), the other vertices such as the three vertices V2, V4, and V0 on the quad face are all visited. Accordingly, a position of V3 is predicted using the within parallelogram prediction as p₃=p₂+p₄−p₀. In an example, when the vertex V2 is to be encoded/decoded, and the vertices V3 and V4 are split vertices (which indicates the vertices V3-V4 have been visited), the other vertices such as the three vertices V3, V4, and V0 on the quad face are all visited. Accordingly, a position of the vertex V2 is predicted using the within parallelogram prediction as p₂=p₀+p₃−p₄, where pᵢ is a position of i-th vertex.

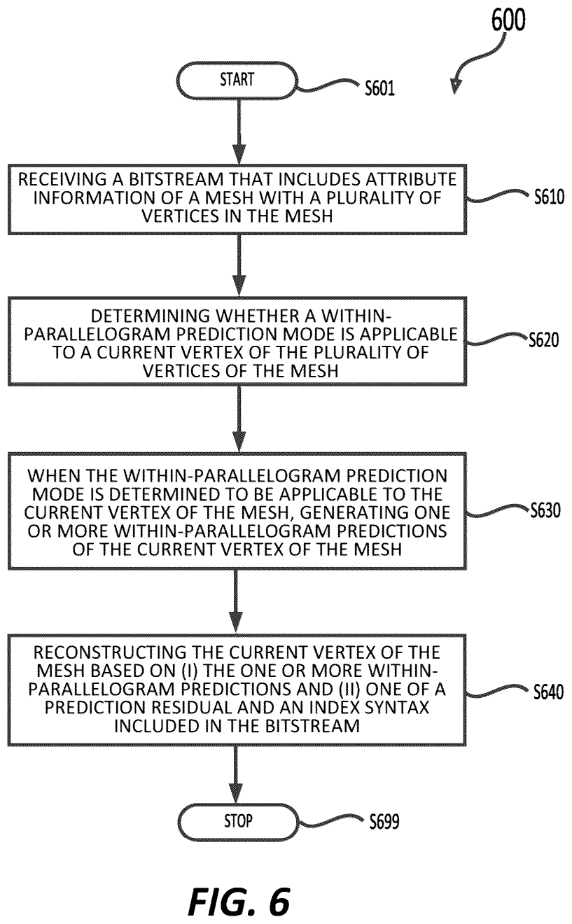

FIG. 6 shows a flow chart outlining a process (600) according to an aspect of the disclosure. The process (600) can be used in a video decoder. In various aspects, the process (600) is executed by processing circuitry, such as the processing circuitry that performs functions of the video decoder (110), the processing circuitry that performs functions of the video decoder (210), and the like. In some aspects, the process (600) is implemented in software instructions, thus when the processing circuitry executes the software instructions, the processing circuitry performs the process (600). The process starts at (S601) and proceeds to (S610).

At (S610), a bitstream that includes attribute information of a mesh with a plurality of vertices in the mesh is received.

At (S620), whether a within-parallelogram prediction mode is applicable to a current vertex of the plurality of vertices of the mesh is determined.

At (S630), when the within-parallelogram prediction mode is determined to be applicable to the current vertex of the mesh, one or more within-parallelogram predictions of the current vertex of the mesh are generated.

At (S640), the current vertex of the mesh is reconstructed based on (i) the one or more within-parallelogram predictions and (ii) one of a prediction residual and an index syntax included in the bitstream.

In an aspect, the within-parallelogram prediction mode is determined to be applicable to the current vertex when a degree of a face that includes the current vertex is equal to or larger than four.

In an aspect, a first within-parallelogram prediction of the one or more within-parallelogram predictions of the current vertex is generated based on three reconstructed neighboring vertices of the current vertex. The three reconstructed neighboring vertices and the current vertex are in a same face of the mesh. The first within-parallelogram prediction and the three reconstructed neighboring vertices form a parallelogram.

In an aspect, the one or more within-parallelogram predictions includes a within-parallelogram prediction. When the prediction residual is included in the bitstream, the current vertex is reconstructed based on the within-parallelogram prediction and the prediction residual.

In an aspect, the one or more within-parallelogram predictions includes a within-parallelogram prediction. When the index syntax is included in the bitstream, a prediction list is determined for the current vertex that includes the within-parallelogram prediction and one or more non-within-parallelogram predictions. The one or more non-within-parallelogram predictions are determined based on one or more non-within-parallelogram prediction modes. The within-parallelogram prediction is a first entry of the prediction list. The current vertex is reconstructed based on a prediction in the prediction list that is identified by the index syntax.

In an aspect, the one or more within-parallelogram predictions includes a plurality of within-parallelogram predictions. When the prediction residual is included in the bitstream, an average value of the plurality of within-parallelogram predictions is determined. The current vertex is reconstructed based on the average value of the plurality of within-parallelogram predictions and the prediction residual.

In an aspect, the one or more within-parallelogram predictions includes a plurality of within-parallelogram predictions. When the index syntax is included in the bitstream, a prediction list is generated for the current vertex that includes an average value of the plurality of within-parallelogram predictions and one or more non-within-parallelogram predictions. The one or more non-within-parallelogram predictions are determined based on one or more non-within-parallelogram prediction modes. The average value of the plurality of within-parallelogram predictions is a first entry of the prediction list. The current vertex is reconstructed based on a prediction in the prediction list that is indicated by the index syntax.

In an aspect, the one or more within-parallelogram predictions includes a plurality of within-parallelogram predictions. When the index syntax is included in the bitstream, a prediction list is generated for the current vertex that includes the plurality of within-parallelogram predictions and one or more non-within-parallelogram predictions. The one or more non-within-parallelogram predictions are determined based on one or more non-within-parallelogram prediction modes. The plurality of within-parallelogram predictions are first entries of the prediction list. The current vertex is reconstructed based on a prediction in the prediction list that is indicated by the index syntax.

In an aspect, the one or more within-parallelogram predictions includes a plurality of within-parallelogram predictions. A prediction list is generated for the current vertex that includes the plurality of within-parallelogram predictions and one or more non-within-parallelogram predictions. The one or more non-within-parallelogram predictions are determined based on one or more non-within-parallelogram prediction modes. The plurality of within-parallelogram predictions are first entries of the prediction list. The current vertex is reconstructed based on a prediction in the prediction list that has a smallest prediction residual or a smallest bitstream size increase.

In an aspect, when the current vertex is included in a quad face of the mesh and other vertices, such as the other three vertices of the quad face, have been visited, a within-parallelogram prediction of the current vertex is generated based on the other vertices of the quad face that have been visited.

Then, the process proceeds to (S699) and terminates.

The process (600) can be suitably adapted. Step(s) in the process (600) can be modified and/or omitted. Additional step(s) can be added. Any suitable order of implementation can be used.

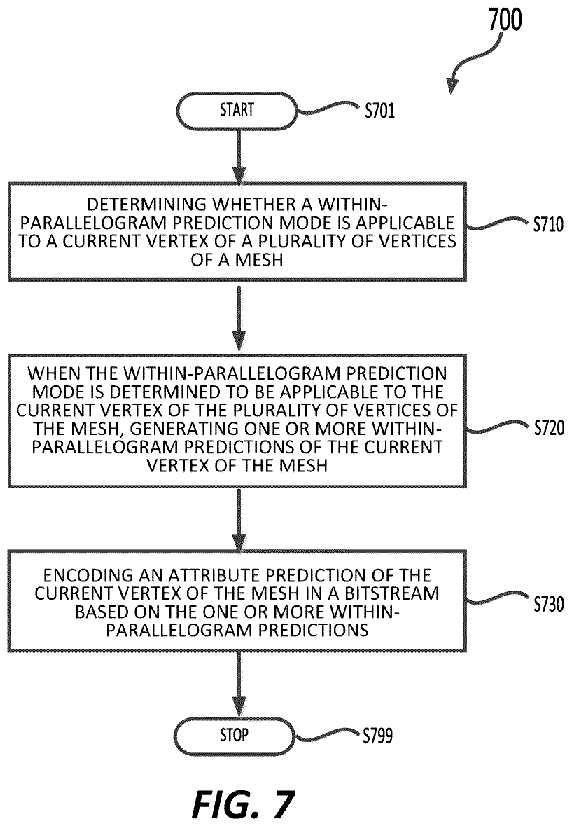

FIG. 7 shows a flow chart outlining a process (700) according to an aspect of the disclosure. The process (700) can be used in a video encoder. In various aspects, the process (700) is executed by processing circuitry, such as the processing circuitry that performs functions of the video encoder (103), the processing circuitry that performs functions of the video encoder (303), and the like. In some aspects, the process (700) is implemented in software instructions, thus when the processing circuitry executes the software instructions, the processing circuitry performs the process (700). The process starts at (S701) and proceeds to (S710).

At (S710), whether a within-parallelogram prediction mode is applicable to a current vertex of a plurality of vertices of a mesh is determined.

At (S720), when the within-parallelogram prediction mode is determined to be applicable to the current vertex of the plurality of vertices of the mesh, one or more within-parallelogram predictions of the current vertex of the mesh are generated.

At (S730), an attribute prediction of the current vertex of the mesh is encoded in a bitstream based on the one or more within-parallelogram predictions.

In an aspect, the within-parallelogram prediction mode is determined to be applicable to the current vertex when a degree of a face that includes the current vertex is equal to or larger than four.

In an aspect, a first within-parallelogram prediction of the one or more within-parallelogram predictions of the current vertex is generated based on three neighboring vertices of the current vertex. The three neighboring vertices and the current vertex are in a face of the mesh. The first within-parallelogram prediction and the three neighboring vertices form a parallelogram.

In an aspect, the one or more within-parallelogram predictions includes a within-parallelogram prediction. The within-parallelogram prediction is determined from a plurality of candidate predictions as the attribute prediction of the current vertex. A prediction residual is encoded in the bitstream based on the within-parallelogram prediction and an original attribute value of the current vertex.

In an aspect, the one or more within-parallelogram predictions includes a within-parallelogram prediction. A prediction list is generated for the current vertex that includes the within-parallelogram prediction and one or more non-within-parallelogram predictions. The one or more non-within-parallelogram predictions are determined based on one or more non-within-parallelogram prediction modes. The within-parallelogram prediction is defined as a first entry of the prediction list. An index syntax is signaled in the bitstream. The index syntax indicates which prediction in the prediction list is determined as the attribute prediction of the current vertex.

In an aspect, the one or more within-parallelogram predictions includes a plurality of within-parallelogram predictions. An average value of the plurality of within-parallelogram predictions is determined as the attribute prediction of the current vertex. A prediction residual is encoded in the bitstream based on the average value of the plurality of within-parallelogram predictions and an original attribute value of the current vertex.

In an aspect, the one or more within-parallelogram predictions includes a plurality of within-parallelogram predictions. A prediction list is generated for the current vertex that includes an average value of the plurality of within-parallelogram predictions and one or more non-within-parallelogram predictions. The one or more non-within-parallelogram predictions are determined based on one or more non-within-parallelogram prediction modes. The average value of the plurality of within-parallelogram predictions is defined as a first entry of the prediction list. An index syntax is signaled in the bitstream. The index syntax indicates which prediction in the prediction list is determined as the attribute prediction of the current vertex.

In an aspect, the one or more within-parallelogram predictions includes a plurality of within-parallelogram predictions. A prediction list is generated for the current vertex that includes the plurality of within-parallelogram predictions and one or more non-within-parallelogram predictions. The one or more non-within-parallelogram predictions are determined based on one or more non-within-parallelogram prediction modes. The plurality of within-parallelogram predictions is defined as first entries of the prediction list. An index syntax is signaled in the bitstream, where the index syntax indicates which prediction in the prediction list is determined as the attribute prediction of the current vertex.

In an aspect, the one or more within-parallelogram predictions includes a plurality of within-parallelogram predictions. A prediction list is generated for the current vertex that includes the plurality of within-parallelogram predictions and one or more non-within-parallelogram predictions. The one or more non-within-parallelogram predictions are determined based on one or more non-within-parallelogram prediction modes. The plurality of within-parallelogram predictions is first entries of the prediction list. The current vertex is encoded based on a prediction in the prediction list that has a smallest prediction residual or a smallest bitstream size increase.

Then, the process proceeds to (S799) and terminates.

The process (700) can be suitably adapted. Step(s) in the process (700) can be modified and/or omitted. Additional step(s) can be added. Any suitable order of implementation can be used.

In an aspect, a method of processing mesh data includes processing a bitstream of the mesh data according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, a bitstream of the mesh data is processed according to a format rule. The bitstream includes attribute information of a mesh with a plurality of vertices in the mesh. The format rule specifies whether a within-parallelogram prediction mode is applicable to a current vertex of the plurality of vertices of the mesh is determined. The format rule specifies that when the within-parallelogram prediction mode is determined to be applicable to the current vertex of the mesh, one or more within-parallelogram predictions of the current vertex of the mesh are generated. The format rule specifies that the current vertex of the mesh is processed based on (i) the one or more within-parallelogram predictions and (ii) one of a prediction residual and an index syntax included in the bitstream.

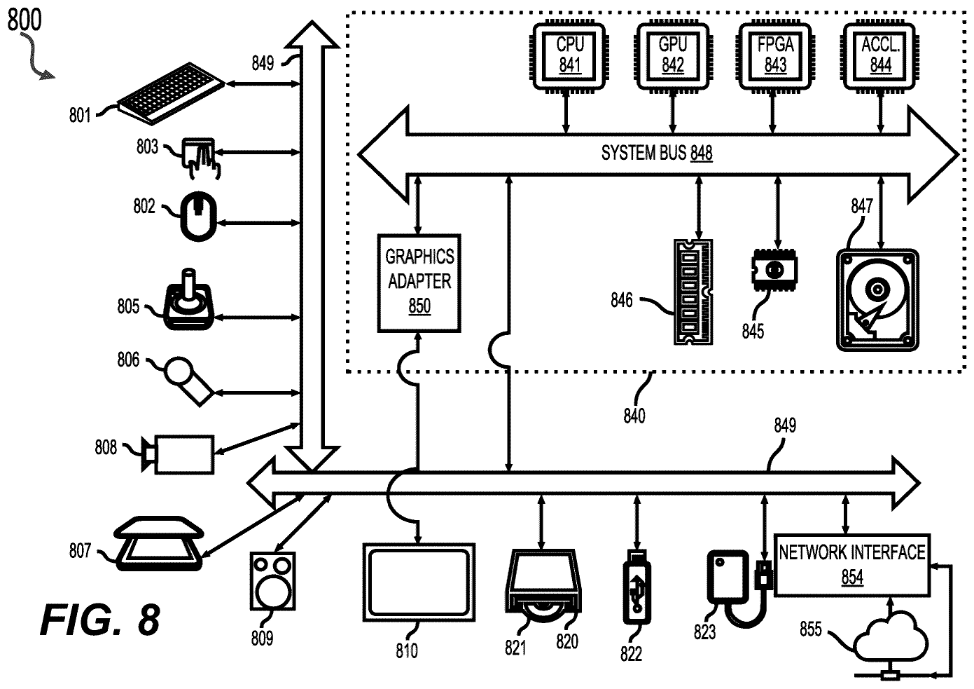

The techniques described above, can be implemented as computer software using computer-readable instructions and physically stored in one or more computer-readable media. For example, FIG. 8 shows a computer system (800) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 8 for computer system (800) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (800).

Computer system (800) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (801), mouse (802), trackpad (803), touch screen (810), data-glove (not shown), joystick (805), microphone (806), scanner (807), camera (808).

Computer system (800) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (810), data-glove (not shown), or joystick (805), but there can also be tactile feedback devices that do not serve as input devices), audio output devices (such as: speakers (809), headphones (not depicted)), visual output devices (such as screens (810) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (800) can also include human accessible storage devices and their associated media such as optical media including CD/DVD ROM/RW (820) with CD/DVD or the like media (821), thumb-drive (822), removable hard drive or solid state drive (823), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (800) can also include an interface (854) to one or more communication networks (855). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (849) (such as, for example USB ports of the computer system (800)); others are commonly integrated into the core of the computer system (800) by attachment to a system bus as described below (for example Ethernet interface into a PC computer system or cellular network interface into a smartphone computer system). Using any of these networks, computer system (800) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (840) of the computer system (800).

The core (840) can include one or more Central Processing Units (CPU) (841), Graphics Processing Units (GPU) (842), specialized programmable processing units in the form of Field Programmable Gate Areas (FPGA) (843), hardware accelerators for certain tasks (844), graphics adapters (850), and so forth. These devices, along with Read-only memory (ROM) (845), Random-access memory (846), internal mass storage such as internal non-user accessible hard drives, SSDs, and the like (847), may be connected through a system bus (848). In some computer systems, the system bus (848) can be accessible in the form of one or more physical plugs to enable extensions by additional CPUs, GPU, and the like. The peripheral devices can be attached either directly to the core's system bus (848), or through a peripheral bus (849). In an example, the screen (810) can be connected to the graphics adapter (850). Architectures for a peripheral bus include PCI, USB, and the like.

CPUs (841), GPUs (842), FPGAs (843), and accelerators (844) can execute certain instructions that, in combination, can make up the aforementioned computer code. That computer code can be stored in ROM (845) or RAM (846). Transitional data can also be stored in RAM (846), whereas permanent data can be stored for example, in the internal mass storage (847). Fast storage and retrieve to any of the memory devices can be enabled through the use of cache memory, that can be closely associated with one or more CPU (841), GPU (842), mass storage (847), ROM (845), RAM (846), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (800), and specifically the core (840) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (840) that are of non-transitory nature, such as core-internal mass storage (847) or ROM (845). The software implementing various aspects of the present disclosure can be stored in such devices and executed by core (840). A computer-readable medium can include one or more memory devices or chips, according to particular needs. The software can cause the core (840) and specifically the processors therein (including CPU, GPU, FPGA, and the like) to execute particular processes or particular parts of particular processes described herein, including defining data structures stored in RAM (846) and modifying such data structures according to the processes defined by the software. In addition or as an alternative, the computer system can provide functionality as a result of logic hardwired or otherwise embodied in a circuit (for example: accelerator (844)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.
(1) A method of mesh decoding, including: receiving a bitstream that includes attribute information of a mesh with a plurality of vertices in the mesh; determining whether a within-parallelogram prediction mode is applicable to a current vertex of the plurality of vertices of the mesh; when the within-parallelogram prediction mode is determined to be applicable to the current vertex of the mesh, generating one or more within-parallelogram predictions of the current vertex of the mesh; and reconstructing the current vertex of the mesh based on (i) the one or more within-parallelogram predictions and (ii) one of a prediction residual and an index syntax included in the bitstream.
(2) The method of feature (1), in which the determining further includes determining that the within-parallelogram prediction mode is applicable to the current vertex when a degree of a face that includes the current vertex is equal to or larger than four.
(3) The method of any of features (1) to (2), in which the generating further includes: generating a first within-parallelogram prediction of the one or more within-parallelogram predictions of the current vertex based on three reconstructed neighboring vertices of the current vertex, the three reconstructed neighboring vertices and the current vertex being in a same face of the mesh, the first within-parallelogram prediction and the three reconstructed neighboring vertices forming a parallelogram.
(4) The method of any of features (1) to (3), in which: the one or more within-parallelogram predictions includes a within-parallelogram prediction; and the reconstructing further includes: when the prediction residual is included in the bitstream, reconstructing the current vertex based on the within-parallelogram prediction and the prediction residual.
(5) The method of any of features (1) to (4), in which: the one or more within-parallelogram predictions includes a within-parallelogram prediction; and the reconstructing further includes: when the index syntax is included in the bitstream, determining a prediction list for the current vertex that includes the within-parallelogram prediction and one or more non-within-parallelogram predictions, the one or more non-within-parallelogram predictions being determined based on one or more non-within-parallelogram prediction modes, the within-parallelogram prediction being a first entry of the prediction list, and reconstructing the current vertex based on a prediction in the prediction list that is identified by the index syntax.
(6) The method of any of features (1) to (5), in which: the one or more within-parallelogram predictions includes a plurality of within-parallelogram predictions; and the reconstructing further includes: when the prediction residual is included in the bitstream, determining an average value of the plurality of within-parallelogram predictions, and reconstructing the current vertex based on the average value of the plurality of within-parallelogram predictions and the prediction residual.
(7) The method of any of features (1) to (6), in which: the one or more within-parallelogram predictions includes a plurality of within-parallelogram predictions; and the reconstructing further includes: when the index syntax is included in the bitstream, generating a prediction list for the current vertex that includes an average value of the plurality of within-parallelogram predictions and one or more non-within-parallelogram predictions, the one or more non-within-parallelogram predictions being determined based on one or more non-within-parallelogram prediction modes, the average value of the plurality of within-parallelogram predictions being a first entry of the prediction list, and reconstructing the current vertex based on a prediction in the prediction list that is indicated by the index syntax.
(8) The method of any of features (1) to (7), in which: the one or more within-parallelogram predictions includes a plurality of within-parallelogram predictions; and the reconstructing further includes: when the index syntax is included in the bitstream, generating a prediction list for the current vertex that includes the plurality of within-parallelogram predictions and one or more non-within-parallelogram predictions, the one or more non-within-parallelogram predictions being determined based on one or more non-within-parallelogram prediction modes, the plurality of within-parallelogram predictions being first entries of the prediction list, and reconstructing the current vertex based on a prediction in the prediction list that is indicated by the index syntax.
(9) The method of any of features (1) to (8), in which: the one or more within-parallelogram predictions includes a plurality of within-parallelogram predictions; and the reconstructing further includes: generating a prediction list for the current vertex that includes the plurality of within-parallelogram predictions and one or more non-within-parallelogram predictions, the one or more non-within-parallelogram predictions being determined based on one or more non-within-parallelogram prediction modes, the plurality of within-parallelogram predictions being first entries of the prediction list, and reconstructing the current vertex based on a prediction in the prediction list that has a smallest prediction residual or a smallest bitstream size increase.
(10) The method of any of features (1) to (9), when the current vertex is included in a quad face of the mesh and other three vertices of the quad face have been visited, a within-parallelogram prediction of the current vertex is generated based on the other three vertices of the quad face that have been visited.
(11) A method of mesh encoding, including: determining whether a within-parallelogram prediction mode is applicable to a current vertex of a plurality of vertices of a mesh; when the within-parallelogram prediction mode is determined to be applicable to the current vertex of the plurality of vertices of the mesh, generating one or more within-parallelogram predictions of the current vertex of the mesh; and encoding an attribute prediction of the current vertex of the mesh in a bitstream based on the one or more within-parallelogram predictions.
(12) The method of feature (11), in which the determining further includes: determining the within-parallelogram prediction mode is applicable to the current vertex when a degree of a face that includes the current vertex is equal to or larger than four.
(13) The method of any of features (11) to (12), in which the generating further includes: generating a first within-parallelogram prediction of the one or more within-parallelogram predictions of the current vertex based on three neighboring vertices of the current vertex, the three neighboring vertices and the current vertex being in a face of the mesh, the first within-parallelogram prediction and the three neighboring vertices forming a parallelogram.
(14) The method of any of features (11) to (13), in which the one or more within-parallelogram predictions includes a within-parallelogram prediction; and the encoding further includes: determining the within-parallelogram prediction from a plurality of candidate predictions as the attribute prediction of the current vertex, and encoding a prediction residual in the bitstream based on the within-parallelogram prediction and an original attribute value of the current vertex.
(15) The method of any of features (11) to (14), in which: the one or more within-parallelogram predictions includes a within-parallelogram prediction; and the encoding further includes: generating a prediction list for the current vertex that includes the within-parallelogram prediction and one or more non-within-parallelogram predictions, the one or more non-within-parallelogram predictions being determined based on one or more non-within-parallelogram prediction modes, the within-parallelogram prediction being defined as a first entry of the prediction list, and signaling an index syntax in the bitstream, the index syntax indicating which prediction in the prediction list is determined as the attribute prediction of the current vertex.
(16) The method of any of features (11) to (15), in which: the one or more within-parallelogram predictions includes a plurality of within-parallelogram predictions; and the encoding further includes: determining an average value of the plurality of within-parallelogram predictions as the attribute prediction of the current vertex, and encoding a prediction residual in the bitstream based on the average value of the plurality of within-parallelogram predictions and an original attribute value of the current vertex.
(17) The method of any of features (11) to (16), in which: the one or more within-parallelogram predictions includes a plurality of within-parallelogram predictions; and the encoding further includes: generating a prediction list for the current vertex that includes an average value of the plurality of within-parallelogram predictions and one or more non-within-parallelogram predictions, the one or more non-within-parallelogram predictions being determined based on one or more non-within-parallelogram prediction modes, the average value of the plurality of within-parallelogram predictions being defined as a first entry of the prediction list, and signaling an index syntax in the bitstream, the index syntax indicating which prediction in the prediction list is determined as the attribute prediction of the current vertex.
(18) The method of any of features (11) to (17), in which: the one or more within-parallelogram predictions includes a plurality of within-parallelogram predictions; and the encoding further includes: generating a prediction list for the current vertex that includes the plurality of within-parallelogram predictions and one or more non-within-parallelogram predictions, the one or more non-within-parallelogram predictions being determined based on one or more non-within-parallelogram prediction modes, the plurality of within-parallelogram predictions being defined as first entries of the prediction list, and signaling an index syntax in the bitstream, the index syntax indicating which prediction in the prediction list is determined as the attribute prediction of the current vertex.
(19) The method of any of features (11) to (18), in which: the one or more within-parallelogram predictions includes a plurality of within-parallelogram predictions; and the reconstructing further includes: generating a prediction list for the current vertex that includes the plurality of within-parallelogram predictions and one or more non-within-parallelogram predictions, the one or more non-within-parallelogram predictions being determined based on one or more non-within-parallelogram prediction modes, the plurality of within-parallelogram predictions being first entries of the prediction list, and encoding the current vertex based on a prediction in the prediction list that has a smallest prediction residual or a smallest bitstream size increase.
(20) A method of processing mesh data, the method including: processing a bitstream of the mesh data according to a format rule, in which: the bitstream includes attribute information of a mesh with a plurality of vertices in the mesh; and the format rule specifies that: whether a within-parallelogram prediction mode is applicable to a current vertex of the plurality of vertices of the mesh is determined; when the within-parallelogram prediction mode is determined to be applicable to the current vertex of the mesh, one or more within-parallelogram predictions of the current vertex of the mesh are generated; and the current vertex of the mesh is processed based on (i) the one or more within-parallelogram predictions and (ii) one of a prediction residual and an index syntax included in the bitstream.
(21) An apparatus for mesh decoding, including processing circuitry that is configured to perform the method of any of features (1) to (10).
(22) An apparatus for mesh encoding, including processing circuitry that is configured to perform the method of any of features (11) to (19).
(23) A non-transitory computer-readable storage medium storing instructions which when executed by at least one processor cause the at least one processor to perform the method of any of features (1) to (19).

What is claimed is:

1. A method of mesh decoding, comprising:
receiving a bitstream that includes attribute information of a mesh with a plurality of vertices in the mesh;
determining whether a within-parallelogram prediction mode is applicable to a current vertex of the plurality of vertices of the mesh;
when the within-parallelogram prediction mode is determined to be applicable to the current vertex of the mesh, generating one or more within-parallelogram predictions of the current vertex of the mesh; and
reconstructing the current vertex of the mesh based on (i) the one or more within-parallelogram predictions and (ii) one of a prediction residual and an index syntax included in the bitstream.

2. The method of claim 1, wherein the determining further comprises:
determining that the within-parallelogram prediction mode is applicable to the current vertex when a degree of a face that includes the current vertex is equal to or larger than four.

3. The method of claim 1, wherein the generating further comprises:
generating a first within-parallelogram prediction of the one or more within-parallelogram predictions of the current vertex based on three reconstructed neighboring vertices of the current vertex, the three reconstructed neighboring vertices and the current vertex being in a same face of the mesh, the first within-parallelogram prediction and the three reconstructed neighboring vertices forming a parallelogram.

4. The method of claim 1, wherein:
the one or more within-parallelogram predictions includes a within-parallelogram prediction; and
the reconstructing further comprises:
when the prediction residual is included in the bitstream, reconstructing the current vertex based on the within-parallelogram prediction and the prediction residual.

5. The method of claim 1, wherein:
the one or more within-parallelogram predictions includes a within-parallelogram prediction; and
the reconstructing further comprises:
when the index syntax is included in the bitstream, determining a prediction list for the current vertex that includes the within-parallelogram prediction and one or more non-within-parallelogram predictions, the one or more non-within-parallelogram predictions being determined based on one or more non-within-parallelogram prediction modes, the within-parallelogram prediction being a first entry of the prediction list, and
reconstructing the current vertex based on a prediction in the prediction list that is identified by the index syntax.

6. The method of claim 1, wherein:
the one or more within-parallelogram predictions includes a plurality of within-parallelogram predictions; and
the reconstructing further comprises:
when the prediction residual is included in the bitstream, determining an average value of the plurality of within-parallelogram predictions, and
reconstructing the current vertex based on the average value of the plurality of within-parallelogram predictions and the prediction residual.

7. The method of claim 1, wherein:
the one or more within-parallelogram predictions includes a plurality of within-parallelogram predictions; and
the reconstructing further comprises:
when the index syntax is included in the bitstream, generating a prediction list for the current vertex that includes an average value of the plurality of within-parallelogram predictions and one or more non-within-parallelogram predictions, the one or more non-within-parallelogram predictions being determined based on one or more non-within-parallelogram prediction modes, the average value of the plurality of within-parallelogram predictions being a first entry of the prediction list, and
reconstructing the current vertex based on a prediction in the prediction list that is indicated by the index syntax.

8. The method of claim 1, wherein:
the one or more within-parallelogram predictions includes a plurality of within-parallelogram predictions; and
the reconstructing further comprises:
when the index syntax is included in the bitstream, generating a prediction list for the current vertex that includes the plurality of within-parallelogram predictions and one or more non-within-parallelogram predictions, the one or more non-within-parallelogram predictions being determined based on one or more non-within-parallelogram prediction modes, the plurality of within-parallelogram predictions being first entries of the prediction list, and
reconstructing the current vertex based on a prediction in the prediction list that is indicated by the index syntax.

9. The method of claim 1, wherein:
the one or more within-parallelogram predictions includes a plurality of within-parallelogram predictions; and
the reconstructing further comprises:
generating a prediction list for the current vertex that includes the plurality of within-parallelogram predictions and one or more non-within-parallelogram predictions, the one or more non-within-parallelogram predictions being determined based on one or more non-within-parallelogram prediction modes, the plurality of within-parallelogram predictions being first entries of the prediction list, and
reconstructing the current vertex based on a prediction in the prediction list that has a smallest prediction residual or a smallest bitstream size increase.

10. The method of claim 1, where the generating further comprises:
when the current vertex is included in a quad face of the mesh and other three vertices of the quad face have been visited,
generating a within-parallelogram prediction of the current vertex based on the other three vertices of the quad face that have been visited.

11. A method of mesh encoding, comprising:
determining whether a within-parallelogram prediction mode is applicable to a current vertex of a plurality of vertices of a mesh;
when the within-parallelogram prediction mode is determined to be applicable to the current vertex of the plurality of vertices of the mesh, generating one or more within-parallelogram predictions of the current vertex of the mesh; and
encoding an attribute prediction of the current vertex of the mesh in a bitstream based on the one or more within-parallelogram predictions.

12. The method of claim 11, wherein the determining further comprises:
determining the within-parallelogram prediction mode is applicable to the current vertex when a degree of a face that includes the current vertex is equal to or larger than four.

13. The method of claim 11, wherein the generating further comprises:
generating a first within-parallelogram prediction of the one or more within-parallelogram predictions of the current vertex based on three neighboring vertices of the current vertex, the three neighboring vertices and the current vertex being in a face of the mesh, the first within-parallelogram prediction and the three neighboring vertices forming a parallelogram.

14. The method of claim 11, wherein:
the one or more within-parallelogram predictions includes a within-parallelogram prediction; and
the encoding further comprises:
determining the within-parallelogram prediction from a plurality of candidate predictions as the attribute prediction of the current vertex, and
encoding a prediction residual in the bitstream based on the within-parallelogram prediction and an original attribute value of the current vertex.

15. The method of claim 11, wherein:
the one or more within-parallelogram predictions includes a within-parallelogram prediction; and
the encoding further comprises:
generating a prediction list for the current vertex that includes the within-parallelogram prediction and one or more non-within-parallelogram predictions, the one or more non-within-parallelogram predictions being determined based on one or more non-within-parallelogram prediction modes, the within-parallelogram prediction being defined as a first entry of the prediction list, and
signaling an index syntax in the bitstream, the index syntax indicating which prediction in the prediction list is determined as the attribute prediction of the current vertex.

16. The method of claim 11, wherein:
the one or more within-parallelogram predictions includes a plurality of within-parallelogram predictions; and
the encoding further comprises:
determining an average value of the plurality of within-parallelogram predictions as the attribute prediction of the current vertex, and
encoding a prediction residual in the bitstream based on the average value of the plurality of within-parallelogram predictions and an original attribute value of the current vertex.

17. The method of claim 11, wherein:
the one or more within-parallelogram predictions includes a plurality of within-parallelogram predictions; and
the encoding further comprises:
generating a prediction list for the current vertex that includes an average value of the plurality of within-parallelogram predictions and one or more non-within-parallelogram predictions, the one or more non-within-parallelogram predictions being determined based on one or more non-within-parallelogram prediction modes, the average value of the plurality of within-parallelogram predictions being defined as a first entry of the prediction list, and
signaling an index syntax in the bitstream, the index syntax indicating which prediction in the prediction list is determined as the attribute prediction of the current vertex.

18. The method of claim 11, wherein:
the one or more within-parallelogram predictions includes a plurality of within-parallelogram predictions; and
the encoding further comprises:
generating a prediction list for the current vertex that includes the plurality of within-parallelogram predictions and one or more non-within-parallelogram predictions, the one or more non-within-parallelogram predictions being determined based on one or more non-within-parallelogram prediction modes, the plurality of within-parallelogram predictions being defined as first entries of the prediction list, and
signaling an index syntax in the bitstream, the index syntax indicating which prediction in the prediction list is determined as the attribute prediction of the current vertex.

19. The method of claim 11, wherein:
the one or more within-parallelogram predictions includes a plurality of within-parallelogram predictions; and
the encoding further comprises:
generating a prediction list for the current vertex that includes the plurality of within-parallelogram predictions and one or more non-within-parallelogram predictions, the one or more non-within-parallelogram predictions being determined based on one or more non-within-parallelogram prediction modes, the plurality of within-parallelogram predictions being first entries of the prediction list, and
encoding the current vertex based on a prediction in the prediction list that has a smallest prediction residual or a smallest bitstream size increase.

20. A method of processing mesh data, the method comprising:
processing a bitstream of the mesh data according to a format rule, wherein:
the bitstream includes attribute information of a mesh with a plurality of vertices in the mesh; and
the format rule specifies that:
whether a within-parallelogram prediction mode is applicable to a current vertex of the plurality of vertices of the mesh is determined;
when the within-parallelogram prediction mode is determined to be applicable to the current vertex of the mesh, one or more within-parallelogram predictions of the current vertex of the mesh are generated; and
the current vertex of the mesh is processed based on (i) the one or more within-parallelogram predictions and (ii) one of a prediction residual and an index syntax included in the bitstream.
